(19) United States
(12) Patent Application Publication
(10) Pub. No.: US 2024/0238970 A1
(43) Pub. Date: Jul. 18, 2024

(54) GENERATING A ROBOT PROGRAM AND OPERATING A ROBOT

(71) Applicant: KUKA Deutschland GmbH, Augsburg (DE)

(72) Inventors: Andreas Hagenauer, Friedberg (DE); Andreas Glueck, Friedberg (DE)

(73) Assignee: KUKA Deutschland GmbH, Augsburg (DE)

(21) Appl. No.: 18/556,755

(22) PCT Filed: Mar. 22, 2022
(86) PCT No.: PCT/EP2022/057413

§ 371 Date: Nov. 2, 2023

(30) Foreign Application Priority Data
Apr. 21, 2021 (DE) 10 2021 204 004.7

(51) Int. Cl. B25J 9/16

(52) U.S. Cl. CPC B25J 9/1664

(57) ABSTRACT

A method for generating a robot program for a robot includes generating a robot program for traversing a robot path, the program having a plurality of movement sets for specifying the path, at least one of which has a specified target pose of a reference of the robot. At least one of the movement sets is a grinding set for which a grinding pose as a virtual starting pose for a successive movement set, an approach to a path section specified by the successive movement set, and an approach from a path section specified by a preceding movement set can be parameterized. A robot path may be traversed by a robot by executing the generated robot program.

### CROSS-REFERENCE TO RELATED APPLICATIONS

This application is a national phase application under 35 U.S.C. § 371 of International Patent Application No. PCT/EP2022/057413, filed Mar. 22, 2022 (pending), which claims the benefit of priority to German Patent Application No. DE 10 2021 204 004.7, filed Apr. 21, 2021, the disclosures of which are incorporated by reference herein in their entirety.

### TECHNICAL FIELD

The present invention relates to a method for generating a robot program for a robot and/or operating a robot, and a system and computer program product for performing the method.

### BACKGROUND

Conventionally, to traverse a robot path, a robot program is created which has multiple successive movement sets which each have a specified target pose of a reference of the robot and specify a section of the path. For example, using the movement sets.
PTP P0
LIN P1
LIN P2

a robot path can be programmed to travel from the TCP pose P0 approached by unsynchronized axle adjustments on a straight line in the working space into pose P1, and from this to travel on a straight line in the working space into pose P2, as illustrated in FIG. 1.

Since the target pose P1 of the movement set LIN P1 forms the starting pose of its successive movement set LIN P2, a problem arises, for example, when different orientations of the TCP are desired on the straight lines [P0; P1] and [P1; P2], for example in order to align a tool stepwise perpendicular to a machining surface or the like. In this case, the orientation would have to be correspondingly switched after traversing the straight lines [P0; P1].

### SUMMARY

The object of the present invention is to improve the operation of robots, preferably to remedy the above problem.

This object is achieved by a method, and a system and computer program product for performing a method as described herein.

According to one embodiment of the present invention, a method for generating a robot program for a robot comprises the step of: generating a robot program on the basis of which, or during the performance or execution of which, a robot traverses a robot path, or which causes the robot to do so, or is configured to do so, wherein the robot program has multiple movement sets which together specify the path in whole or in part, in particular specify in each case a subsection of the path, wherein one or more of these movement sets of the robot program each has a specified target pose of a reference, in an embodiment of the TCP or of a tool, of the robot.

According to one embodiment of the present invention, one of these movement sets or multiple these movement sets (in each case) is a grinding set for which (in each case):
a grinding pose as a virtual starting pose for a successive movement set,
an approach to a path section specified by said successive movement set, and
an approach from a path section specified by a preceding movement set

can be parameterized, in one embodiment is parameterized, in one embodiment, only the grinding pose, only the approach to the path section specified by the successive movement set, the approach from the path section specified by the preceding movement set, only the grinding pose and the approach to the path section specified by the successive movement set, only the grinding pose and the approach from the path section specified by the preceding movement set, only the approach to the path section specified by the successive movement set and the approach from the path section specified by the preceding movement set, or both the grinding pose and the approach to the path section specified by the successive movement set as well as the approach from the path section specified by the preceding movement set are parameterized.

Accordingly in one embodiment, an advantageous robot path can be programmed, and/or a robot path can be advantageously programmed easily, reliably, and/or quickly. If, in one embodiment, the grinding pose will be or is parameterized as a virtual starting pose for the successive movement set (in each case) for the one or more of the grinding sets, in one embodiment, a reorientation and/or repositioning can advantageously, in particular easily, be (more) reliably and/or (more) quickly programmed, and/or an advantageous reorientation and/or repositioning can be programmed. If (additionally or alternatively) in one embodiment (in each case) an approach to a path section predefined by the (respective) successive movement set will be or is parameterized for the one or more of the grinding sets, in one embodiment a desired or advantageous placement onto this path section can be advantageously programmed, in particular (more) simply, (more) reliably and/or (more) quickly. If (additionally or alternatively), in one embodiment for the one or more of the grinding sets (in each case), an approach from a path section predefined by a preceding movement set of the corresponding grinding set will be or is parameterized, in one embodiment a desired or advantageous and/or permissible deviation from this path section can be advantageously programmed, in particular more easily, more reliably, and/or more quickly.

Accordingly, during the generation of the robot program in one embodiment, one or more grinding sets are used as movement sets, which in each case enable a parameterization of a grinding pose as a virtual starting pose for a successive movement set, an approach of a path section predefined by this successive movement set, as well as an approach from a path section specified by a preceding movement set, or are configured for this purpose or have a corresponding parameterization option, or in which a corresponding parameterization option is provided, wherein in a further development in one or more of these grinding or movement sets (in each case), a grinding pose will be or is parameterized as a virtual starting pose for a successive movement set. Additionally or alternatively in a further development, in the one or more of the grinding or movement sets (in each case), an approach to a path section predetermined by the successive movement set (of the corresponding grinding set) is parameterized. Additionally or alternatively, in a further development in the one or more of the grinding or movement sets (in each case), an approach from a path section predetermined by a preceding movement set (of the respective grinding set) is parameterized.

In one embodiment, in the parameterized approach to the path section specified by this successive movement set, said successive movement set or path section of the robot program is cut off by the preceding grinding set or path section specified thereby, or the corresponding part of the successor movement set or path section specified thereby is replaced by the parameterized approach, or in the parameterized approach from the path section specified by the preceding movement set, said preceding movement set or path section of the robot program is cut off by the subsequent grinding set or path section specified thereby, or the corresponding part of the preceding movement set or path section specified thereby is replaced by the parameterized approach.

In one embodiment, for the one or more of the grinding sets, in each case a distance from its grinding pose, within which a position of the reference may deviate from a path section specified by the successive movement set (of the respective grinding set), can be parameterized, or a corresponding parameterization option is provided, wherein in a further embodiment, in the one or more of these grinding or movement sets (in each case), such a distance will be or is parameterized.

Additionally or alternatively, for the one or more of the grinding sets, in each case a distance from its grinding pose, within which an orientation of the reference may deviate from a path section specified by the successive movement set, can be parameterized, or a corresponding parameterization option is provided, wherein in a further embodiment, in the one or more of these grinding or movement sets (in each case), such a distance will be or is parameterized.

Additionally or alternatively, for the one or more of the grinding sets, in each case a distance from its grinding pose, within which a position of the reference may deviate from a path section specified by the preceding movement set, can be parameterized, or a corresponding parameterization option is provided, wherein in a further embodiment, in the one or more of these grinding or movement sets (in each case), such a distance will be or is parameterized.

Additionally or alternatively, for the one or more of the grinding sets, in each case a distance from its grinding pose, within which an orientation of the reference may deviate from a path section specified by the preceding movement set, can be parameterized, or a corresponding parameterization option is provided, wherein in a further embodiment, in the one or more of these grinding or movement sets (in each case), such a distance will be or is parameterized.

Additionally or alternatively, for the one or more of the grinding sets, in each case a distance from a pose, preferably the start or end pose, of the successive movement set of this grinding pose, within which a position of the reference may deviate from a path section specified by the successive movement set, can be parameterized, or a corresponding parameterization option is provided, wherein in a further embodiment, in the one or more of these grinding or movement sets (in each case), such a distance will be or is parameterized.

Additionally or alternatively, for the one or more of the grinding sets, in each case a distance from a pose, preferably the start or end pose, of the successive movement set of this grinding pose, within which an orientation of the reference may deviate from a path section specified by the successive movement set, can be parameterized, or a corresponding parameterization option is provided, wherein in a further embodiment, in the or one or more of these grinding or movement sets (in each case), such a distance will be or is parameterized.

Additionally or alternatively, for the or one or more of the grinding sets, in each case a distance from a pose, preferably the start or end pose, of the preceding movement set of this grinding set, within which a position of the reference may deviate from a path section specified by the preceding movement set, can be parameterized, or a corresponding parameterization option is provided, wherein in a further embodiment, in the or one or more of these grinding or movement sets (in each case), such a distance will be or is parameterized.

Additionally or alternatively, for the one or more of the grinding sets, in each case a distance from a close, preferably the start or end pose, of the preceding movement set of this grinding set, within which an orientation of the reference may deviate from a path section specified by the preceding movement set, can be parameterized, or a corresponding parameterization option is provided, wherein in a further embodiment, in the one or more of these grinding or movement sets (in each case), such a distance will be or is parameterized.

Additionally or alternatively, a distance dimension of the reference relative to the grinding pose during the execution of the grinding set can be parameterized, or a corresponding parameterization option is provided for the one or more of the grinding sets, wherein in a further development (in each case), such a distance dimension will be or is parameterized in the or one or more of these grinding or movement sets, and/or the distance dimension depends on a distance, which in one embodiment is Cartesian, of the reference of the robot from the respective grinding pose, in a further development is equal to the distance.

As a result, in one embodiment, in particular in combination of two or more of these features, a particularly advantageous robot path and/or a robot path can be programmed particularly advantageously, in particular simply, reliably and/or quickly, in particular a reorientation and/or repositioning and/or a desired or advantageous deviation from the corresponding path section.

In one embodiment, in a further development by parameterizing the distance dimension, a mandatory traversing of the grinding pose can be specified; in a further development, a mandatory traversing of the grinding pose will be or is specified for the or one or more of the grinding sets (in particular by corresponding parameterization).

This can be particularly advantageous, for example, for painting paths or the like in order to ensure that desired workpiece regions are painted.

Additionally or alternatively, in one embodiment, in a further development by corresponding parameterization, in particular of the distance dimension, a non-mandatory traversing of the grinding pose can be specified; in a further development, a mandatory traversing of the grinding pose will be or is specified for the one or more of the grinding sets (in particular by corresponding parameterization).

This can be particularly advantageous, for example, for adhesive beads or the like, in which sufficient proximity to certain workpiece regions can be sufficient, but an approach of these workpiece regions is not ruled out, and may even be particularly advantageous. Correspondingly, specifying a non-mandatory traversing of a grinding pose in one embodiment is understood to mean that (although) the traversing is permitted or possible, it is not (necessarily) required or prescribed

Additionally or alternatively, in one embodiment, in a further development by parameterization of the distance dimension, an impermissible traversing of the grinding pose can be specified; in a further development, an impermissible traversing of the grinding pose will be or is specified for the or one or more of the grinding sets (in particular by corresponding parameterization).

This can be particularly advantageous, for example, to avoid collisions.

In one embodiment, an impermissible traversing of a grinding pose by specifying or parameterizing a minimum distance dimension (different from zero) relative to the grinding pose is or will be specifiable or specified, or a minimum distance dimension (other than zero) relative to the grinding pose is or will be specifiable or specified for an impermissible, or when there is an impermissible, traversing of a grinding pose.

Additionally or alternatively, in one embodiment, a maximum distance dimension (different from zero) relative to the grinding pose is or will be specifiable or specified for or when there is a non-mandatory traversing of a grinding pose.

In one embodiment, the minimum or maximum distance dimension indicates a lower (minimum distance) or upper (maximum distance) limit value for the distance dimension which the reference must maintain or possess at a minimum (minimum distance dimension) or at a maximum (maximum distance) relative to the grinding pose when traversing the grinding set.

Additionally or alternatively, in one embodiment, a deposition direction relative to the grinding pose is or will be specifiable or specified in one embodiment for an impermissible or non-mandatory, or when there is an impermissible or non-mandatory, traversing of a grinding pose, for example if the reference of the robot, for example relative to the path section(s) specified by the preceding and/or successive movement set, should (optionally) travel past the grinding pose or the like on the outside or on the inside. In this case, a deposition direction relative to the grinding pose can in particular specify whether the reference should deviate from the grinding pose toward or away from path sections specified by the preceding and/or successive movement set.

In one embodiment, one or more boundary surfaces can be parameterized for the one or more of the grinding sets; in one further development, at least one boundary surface is or will be parameterized for the one or more of the grinding sets (in each case), in one embodiment by specifying one or more points of the boundary surface and/or a surface normal of the boundary surface. In one embodiment, the reference of the robot does not penetrate the boundary surface while traversing the grinding set or in the approach to the path section specified by its successive movement set or in the approach from the path section specified by its preceding movement set; in one embodiment, it can touch it, or the movement (of the reference) of the robot is or will be correspondingly planned or controlled when traversing the grinding set, or in the approach to the path section specified by its successive movement set, or in the approach from the path section specified by its preceding movement set. In one embodiment, for the approach to the path section specified by the successive movement set and the approach from the path section specified by the preceding movement set, different boundary surfaces can be parameterized; in one further development, for the approach to the path section specified by the successive movement set and the approach from the path section specified by the preceding movement set, different boundary surfaces are or will be parameterized.

In one embodiment, this makes it possible to program a desired or advantageous approach or continuation, in particular departure, in a particularly advantageous manner, in particular simply, reliably and/or quickly.

In one embodiment, at least one strategy for an unfulfillable restriction of the one or more of the grinding sets is parameterizable; in one further development, at least one strategy for an unfulfillable restriction is or will be parameterized for the one or more of the grinding sets (in each case). Such a strategy can in particular comprise outputting a message, in particular a warning or error message, stopping the robot, or the like.

In one embodiment, this allows the robot path to be very advantageous, and/or to be very advantageously, in particular simply, reliably and/or quickly programmed.

In one embodiment, a speed for traversing the one or more of the grinding sets is parameterizable; in a further development, a speed for the traversing of the, or the one or more of the, grinding sets is or will be parameterized.

As a result, in one embodiment, a robot path can be particularly advantageous and/or can be programmed particularly advantageously, in particular simply, reliably and/or quickly, in particular a reorientation and/or repositioning and/or a desired or advantageous deviation from the corresponding path section.

In one embodiment, a grinding set for its part can be, or can be used as, the successive movement set of at least one grinding set; in a further development, a grinding set for its part can be, or can be used as, the successive movement set of at least one grinding set. Additionally or alternatively, in one embodiment, a grinding set for its part can be, or can be used as, the preceding movement set of at least one grinding set; in a further development, a grinding set for its part can be, or can be used as, the preceding movement set of at least one grinding set. In other words, in one embodiment, two or more grinding sets can directly follow each or be strung together.

In one embodiment, this allows a robot path to be very advantageous, and/or to be very advantageously, in particular simply, reliably and/or quickly programmed, in particular very flexibly.

According to one embodiment of the present invention, a method of operating a robot comprises the step of: traversing a robot path by the robot by executing a robot program that is (has been) generated according to a method described herein, in a further embodiment in addition to the generation of the robot program in the manner described herein. Accordingly, in one embodiment, the method for operating a robot comprises the steps: generating a robot program in the manner described here, and traversing a robot path by the robot by executing this robot program. By using or executing a robot program generated according to a method described here, in one embodiment, the operation of the robot can be improved, in particular reliability, precision and/or flexibility can be increased, and/or energy consumption and/or a robot load can be reduced.

In one embodiment, the traversing of a grinding set, or of a path section specified by this grinding set, comprises the optionally parameterized approach of the path section specified by its successive movement set and/or approach of the path section specified by its preceding movement set, in particular can consist thereof. Likewise, in one embodiment, a further path section of the grinding set can be present between the approach from the path section specified by the preceding movement set and the approach to the path section specified by the successive movement set. In one embodiment, the path section specified by the grinding set and the path section specified by the preceding movement set and/or the path section specified by the grinding set and the path section specified by the successive movement set transition steadily, preferably smoothly into each other.

According to one embodiment of the present invention, a system for generating a robot program and/or operating a robot, is configured to perform a method described herein, in particular in terms of hardware and/or software, in particular programming, and/or has
means for generating a robot program for traversing a robot path, which comprises multiple movement sets for specifying the path, at least one of which has a specified target pose of a reference of the robot, wherein at least one of the movement sets is a grinding set for which a grinding pose as a virtual starting pose for a successive movement set, an approach to a path section specified by said successive movement set, and an approach from a path section specified by a preceding movement set can be parameterized; and/o
means for traversing a robot path by a robot by executing a robot program that is generated according to a method described here.

In one embodiment, the system or its means comprises:
means for parameterizing a distance for the at least one grinding set, within which a position of the reference may deviate from a path section specified by the successive movement set, from the grinding pose of the grinding set;
means for parameterizing a distance for the at least one grinding set, within which a position of the reference may deviate from a path section specified by the successive movement set, from a pose of the successive movement set of this grinding set;
means for parameterizing a distance for the at least one grinding set, within which an orientation of the reference may deviate from a path section specified by the successive movement set, from the grinding pose of the grinding set;
means for parameterizing a distance for the at least one grinding set, within which an orientation of the reference may deviate from a path section specified by the successive movement set, from a pose of the successive movement set of this grinding set;
means for parameterizing a distance for the at least one grinding set, within which a position of the reference may deviate from a path section specified by the preceding movement set, from the grinding pose of the grinding set;
means for parameterizing a distance for the at least one grinding set, within which a position of the reference may deviate from a path section specified by the preceding movement set, from a pose of the preceding movement set of this grinding set;
means for parameterizing a distance for the at least one grinding set, within which an orientation of the reference can deviate from a path section specified by the preceding movement set, from the grinding pose of the grinding set;
means for parameterizing a distance for the at least one grinding set, within which an orientation of the reference may deviate from a path section specified by the preceding movement set, from a pose of the preceding movement set of this grinding set; and/or
means for parameterizing a distance dimension of the reference relative to the grinding pose of the grinding set when traversing the grinding set for the at least one grinding set.

In one embodiment, the system or its means comprises:
means for specifying a mandatory traversing, a non-mandatory or impermissible traversing of the grinding pose, in particular a minimum or maximum distance dimension relative to the grinding pose and/or a deposition direction with respect to the grinding pose;
means for parameterizing at least one boundary surface for the grinding set;
means for parameterizing at least one strategy for an unfulfillable restriction of the grinding set;
means for parameterizing a speed for traversing the grinding set;
and/or means for stringing together at least two grinding sets.

A system and/or a means within the meaning of the present invention may be designed in hardware and/or in software, and in particular may comprise a data-connected or signal-connected, in particular, digital, processing unit, in particular microprocessor unit (CPU), graphic card (GPU) having a memory and/or bus system or the like and/or one or multiple programs or program modules. The processing unit may be designed to process commands that are implemented as a program stored in a memory system, to detect input signals from a data bus and/or to output output signals to a data bus. A storage system may comprise one or a plurality of, in particular different, storage media, in particular optical, magnetic, solid-state, and/or other non-volatile media. The program may be designed in such a way that it embodies or is capable of performing the methods described herein, so that the processing unit is able to carry out the steps of such methods and therefore in particular can provide a programming option or environment for generating a robot program, and/or is able to operate the robot. In particular, a system and/or means within the meaning of the present invention can in particular be a programming environment, programming language, and/or program library. In one embodiment, a computer program product may comprise—and may in particular be—an in particular non-volatile storage medium for storing a program, or having a program stored thereon, an execution of this program causing a system or a controller, in particular a computer, to carry out the method described herein, or one or more steps thereof.

In one embodiment, one or more, in particular all, steps of the method are performed completely or partially automatically, in particular by the system or its means.

In one embodiment, the system comprises the robot.

Operating a robot within the meaning of the present invention comprises, in one embodiment, generating a robot program and/or executing a or the robot program by or with a robot; in particular, it can consist of the generation of a robot program, the execution of a or the robot program by or with a robot, or the generation of a robot program and the execution of a robot program by or with a robot.

In one embodiment, a computer program product comprises a program code, which is stored on a computer-readable medium, for performing a method according to the present disclosure.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 shows a conventionally programmed robot path of a TCP of a robot;

FIGS. 2-6 show robot paths of a TCP of a robot programmed according to an embodiment of the present invention;

FIG. 7 shows a system according to an embodiment of the present invention; and

FIG. 8 shows a method according to an embodiment of the present invention.

### DETAILED DESCRIPTION

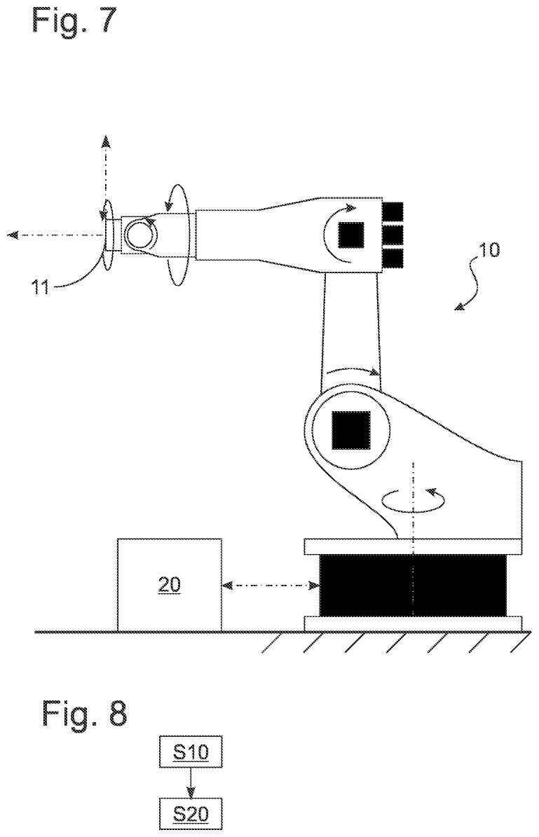

FIG. 1 illustrates a robot path of a TCP 11 of a robot 10 (see FIG. 7), which will be or is programmed in a conventional manner, for example by the movement sets:
PTP P0
LIN P1
LIN P2

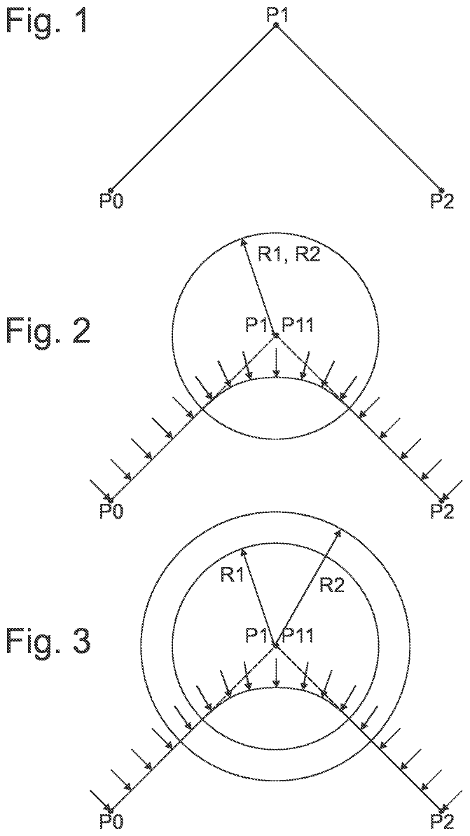

FIG. 2 illustrates a robot path which will be or is programmed according to one embodiment of the present invention, for example by the movement sets:
PTP P0
LIN P1
BLEND P11 with BLENDPARA
LIN P2

In this case, “BLEND P11 with BLENDPARA” is a grinding set with the grinding pose P11 and the parameters BLENDPARA.

In this embodiment, the grinding pose P11 comprises only the orientation of the target pose P2 of the successive movement set LIN P2; the position is therefore not changed or corresponds to the position of the target pose P1 of the preceding movement set LIN P1. Accordingly, for the successive movement set LIN P2 with P11, an orientation deviating from the target pose of the preceding movement set LIN P1 can be specified as a virtual starting pose, and a desired orientation can thereby be realized on a path section specified by the successive movement set.

With the parameters BLENDPARA, for example, a radius R1 around the grinding pose P11 will be or is parameterized, from which a position of the TCP is allowed to deviate from the path section specified by the preceding movement set LIN P1 and the path section specified by the successive movement set LIN P2.

In addition or alternatively, with the parameters BLENDPARA, for example, a radius R2 around the grinding pose P11 can be parameterized, from which an orientation of the TCP indicated by arrows in FIG. 2 may deviate from the path section specified by the preceding movement set LIN P1 and the path section specified by the successive movement set LIN P2. The two radii R1, R2 can be identical (FIG. 2) or different. The latter is illustrated in FIG. 3 which otherwise corresponds to FIG. 2.

In a modification, different radii can be or are parameterized for the deviation from the position of the preceding movement set LIN P1 and for the deviation from the position of the successive movement set LIN P2. Additionally or alternatively, different radii can be or are parameterized for the deviation from the orientation of the preceding movement set LIN P1 and for the deviation from the orientation of the successive movement set LIN P2.

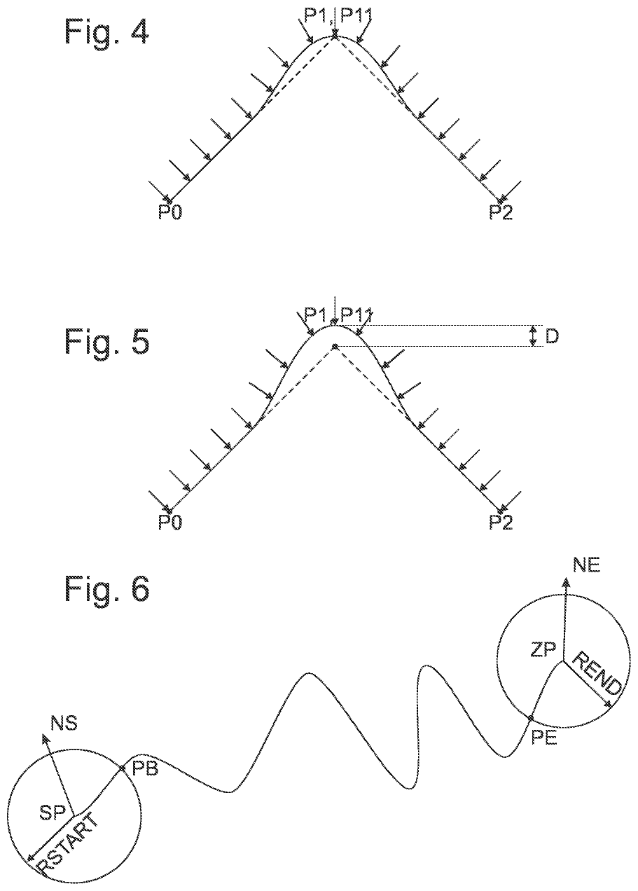

Additionally or alternatively, with the parameters BLENDPARA, it can be or is specified whether the grinding pose P11 does or does not have to be traversed when traversing the grinding set BLEND P11 with BLENDPARA. FIGS. 2, 3 show a non-mandatory traversing; FIG. 4, which otherwise corresponds to FIG. 2, illustrates a specified traversing of the grinding pose P11; FIG. 5, which otherwise corresponds to FIGS. 2 and 4, illustrates by way of example a specified minimum distance dimension D which depends on a distance from the grinding pose P11, in particular can be the same as the (minimum) distance, and a deposition direction with respect to the grinding pose P11, in the exemplary embodiment, a bypassing of the grinding pose P11 from the outside, relative to the orientation or preceding and successive movement set LIN P1, LIN P2.

FIG. 6 illustrates a robot path which will be or is programmed according to a further embodiment of the present invention, for example by the movement sets:
BLEND SP with BLENDPARA1
SPLINE
. . .
SPL ZP
ENDSPLINE
BLEND with BLENDPARA2

With the parameters BLENDPARA1 of the first grinding set “BLEND SP with BLENDPARA1” with the parameterized grinding pose SP, it will be or is specified, for example, that within a specified distance from SP, which is indicated by RSTART in FIG. 6, the position and/or orientation may deviate from the spline path specified by the successive movement set. In this way, it is ensured that the spline path is followed from the point PB onwards, for example to apply an adhesive bead with a correspondingly oriented tool or the like. In addition or alternatively, the parameters BLENDPARA1 can be used to parameterize, for example, a plane that contains SP with the (outward) surface normal, that is indicated in FIG. 6 by NS, which may be touched but not penetrated when traversing within RSTART.

The second grinding set “BLEND with BLENDPARA2” has the effect that, from the point PE with a distance REND from ZP, the position and/or orientation may again deviate from the spline path, wherein by the parameters BLENDPARA2, a plane that contains ZP can again be parameterized with the (outward) surface normal which is indicated in FIG. 6 with NE, and may be touched but not penetrated when traversing within REND.

In this case, the second grinding set BLEND with BLENDPARA2 illustrates that a grinding pose does not necessarily have to be, or must be, parameterized for a grinding set, in particular if, as here, a successive movement set is not provided for which such a grinding pose determines or would determine a virtual start pose.

In addition, the two grinding sets illustrate that an approach from a path section specified by a preceding movement set (see first grinding set) or an approach to a path section specified by a successive movement set (see second grinding set) does not necessarily have to exist or be parameterized.

With 20, FIG. 7 indicates a computer for programming and/or controlling the robot 10 that is configured or used to perform a method described herein. In one embodiment, a robot path described here is traversed by the robot 10 by executing a robot program which is or has been generated according to a method described here. This is illustrated by FIG. 8 in which the robot program is generated in step S10 and executed in step S20.

Although embodiments have been explained in the preceding description, it is noted that a large number of modifications are possible. It is also noted that the embodiments are merely examples that are not intended to restrict the scope of protection, the applications, and the structure in any way. Rather, the preceding description provides a person skilled in the art with guidelines for implementing at least one embodiment, wherein various changes—in particular with regard to the function and arrangement of the described components—can made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

10 Robot
11 TCP
20 Control
P0, P1, P2, ZP Target pose
P11, SP Grinding pose
PB, PE Path point
D Minimum distance dimension
NS, NE (Outward) surface normal
R1, R2, RSTART, REND Distance

What is claimed is:

1-15. (canceled)

16. A method for generating a robot program for a robot to traverse a robot path, wherein the robot program includes multiple movement sets for specifying the path, wherein at least one of the movements sets has a specified target pose of a reference of the robot, and wherein at least one of the movement sets is a blending set, the method comprising parameterizing, for at least one blending set:
a blending pose as a virtual starting pose for a successive movement set;
an approach to a path section specified by the successive movement set; and
an approach from a path section specified by a preceding movement set.

17. The method of claim 16, further comprising parameterizing, for the at least one blending set, at least one of:
a distance from the blending pose of the blending set within which a position of the reference may deviate from a path section specified by the successive movement set;
a distance from a pose of the successive movement set of the blending set within which a position of the reference may deviate from a path section specified by the successive movement set;
a distance from the blending pose of the blending set within which an orientation of the reference may deviate from a path section specified by the successive movement set;
a distance from a pose of the successive movement set of the blending set within which an orientation of the reference may deviate from a path section specified by the successive movement set;
a distance from the blending pose of the blending set within which a position of the reference may deviate from a path section specified by the preceding movement set;
a distance from a pose of the preceding movement set of the blending set within which a position of the reference may deviate from a path section specified by the preceding movement set;
a distance from the blending pose of the blending set within which an orientation of the reference may deviate from a path section specified by the preceding movement set;
a distance from a pose of the preceding movement set of the blending set within which an orientation of the reference may deviate from a path section specified by the preceding movement set; or
a distance dimension of the reference relative to the blending pose of the blending set while traversing the blending set.

18. The method of claim 17, further comprising specifying at least one of:
a mandatory traversing of the blending pose;
a non-mandatory traversing of the blending pose;
an impermissible traversing of the blending pose; or
a deposition direction relative to the blending pose.

19. The method of claim 18, wherein at least one of:
specifying comprises parameterizing the distance dimension; or
specifying an impermissible traversing of the blending pose comprises specifying a minimum and/or maximum distance dimension relative to the blending pose.

20. The method of claim 16, further comprising parameterizing at least one boundary surface for the at least one blending set.

21. The method of claim 16, further comprising parameterizing at least one response to an unfulfillable restriction of the at least one blending set.

22. The method of claim 16, further comprising parameterizing a speed for traversing the at least one blending set.

23. The method of claim 16, wherein two or more of the movement sets are blending sets that are interconnected.

24. A method for operating a robot, comprising:
obtaining a robot program which is generated according to the method of claim 16; and
traversing a robot path with the robot by executing the robot program.

25. A system for generating a robot program for a robot to traverse a robot path, wherein the robot program includes multiple movement sets for specifying the path, wherein at least one of the movements sets has a specified target pose of a reference of the robot, and wherein at least one of the movement sets is a blending set, the system comprising means for parameterizing, for the at least one blending set:
a blending pose as a virtual starting pose for a successive movement set;
an approach to a path section specified by said successive movement set; and
an approach from a path section specified by a preceding movement set.

26. The system of claim 25, further comprising means for traversing a robot path with the robot by executing the robot program generated by the system.

27. The system of claim 25, further comprising means for parameterizing, for the at least one blending set, at least one of:
a distance from the blending pose of the blending set within which a position of the reference may deviate from a path section specified by the successive movement set;
a distance from a pose of the successive movement set of the blending set within which a position of the reference may deviate from a path section specified by the successive movement set;
a distance from the blending pose of the blending set within which an orientation of the reference may deviate from a path section specified by the successive movement set;
a distance from a pose of the successive movement set of the blending set within which an orientation of the reference may deviate from a path section specified by the successive movement set;
a distance from the blending pose of the blending set within which a position of the reference may deviate from a path section specified by the preceding movement set;
a distance from a pose of the preceding movement set of the blending set within which a position of the reference may deviate from a path section specified by the preceding movement set;
a distance from the blending pose of the blending set within which an orientation of the reference may deviate from a path section specified by the preceding movement set;
a distance from a pose of the preceding movement set of the blending set within which an orientation of the reference may deviate from a path section specified by the preceding movement set; or
a distance dimension of the reference relative to the blending pose of the blending set while traversing the blending set.

28. The system of claim 25, further comprising means for specifying at least one of:
a mandatory traversing of the blending pose;
a non-mandatory traversing of the blending pose;
an impermissible traversing of the blending pose; or
a deposition direction relative to the blending pose.

29. The system of claim 28, wherein at least one of:
the means for specifying comprises means for parameterizing the distance dimension; or
the means for specifying an impermissible traversing of the blending pose comprises means for specifying a minimum and/or maximum distance dimension relative to the blending pose.

30. The system of claim 25, further comprising means for parameterizing at least one boundary surface for the at least one blending set.

31. The system of claim 25, further comprising means for parameterizing at least one response to an unfulfillable restriction of the at least one blending set.

32. The system of claim 25, further comprising at least one of:
means for parameterizing a speed for traversing the at least one blending set; or
means for stringing together at least two blending sets.

33. A computer program product comprising program code stored on a non-transitory, computer-readable storage medium, the program code configured to, when executed by a computer, cause the computer to perform the method of claim 16.
